(19) United States
(12) Patent Application Publication
(10) Pub. No.: US 2011/0077965 A1
(43) Pub. Date: Mar. 31, 2011

(54) PROCESSING EVENT INFORMATION OF VARIOUS SOURCES

(75) Inventors: MARK ALLEN NOLTE, LEE'S SUMMIT, MO (US); DAMON MATTHEW HERBST, SHAWNEE, KS (US); RYAN CHRISTOPHER CALDER, LIBERTY, MO (US); PAUL CANNON, KANSAS CITY, MO (US)

(73) Assignee: CERNER INNOVATION, INC., OVERLAND PARK, KS (US)

(21) Appl. No.: 12/567,174

(22) Filed: Sep. 25, 2009

(51) Int. Cl. G06Q 50/00

(52) U.S. Cl. 705/3; 705/2

(57) ABSTRACT

An embodiment of the present invention is directed to providing event information that is received from various sources in a healthcare environment. The information that is received from the various sources is converted to a standardized format and is filtered according to various criteria (e.g., source device, recipient component, event type, source location, etc.). After filtering, the information is compared to a rules engine to determine whether additional processing or routing is appropriate.

### BACKGROUND

In a healthcare environment, various sources capture, communicate, and store information, such as monitored values of a patient, locations of a person or a device, equipment utilization, etc. Exemplary sources of information include medical devices that monitor patients, real-time locator systems, nurse-call systems, patient-bedside systems, communication systems (e.g., in-house phone, mobile device, pager, etc.), and a healthcare information system. These various sources are typically not integrated with one another in a manner that allows information from one source to be combined with information of other sources. Integrating these sources into a single solution would enable a more efficient combination and use of captured information.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The present invention is defined by the claims.

The present invention is directed to providing event information that is received from various sources in a healthcare environment. In an exemplary embodiment, the information that is received from the various sources is converted to a standardized format. Once converted to a standardized format, the information is filtered according to various criteria (e.g., source device, recipient component, event type, source location, etc.) and stored. After filtering, the information is compared to a rules engine to determine whether additional processing and/or routing is appropriate.

In another exemplary embodiment of the present invention a first event indication, which describes an alarm-triggering event, is received from a medical device. A rules engine is referenced to determine that when the medical device detects the alarm-triggering event a notification is to be provided to a notification recipient. A patient-to-device data store is referenced to receive a patient identifier, which identifies a patient that is associated with the medical device. The patient identifier is used to retrieve patient-specific information, and the recipient is provided with the notification, which indicates both the event and the patient-specific information.

In another embodiment, a method of providing event information includes receiving from a medical device a first event indication, which indicates an instant in time at which an active state of the medical device begins. A second event indication, which indicates a subsequent instant in time at which the medical device changes from the active state to an inactive state, is received from the medical device. An active-state-duration value is stored that quantifies a duration of the active state between the instant in time and the subsequent instant in time. Based on the active-state-duration value and other active-state-duration values, it is determined that the medical device should receive a type of maintenance. A notification is provided indicating that the medical device should receive the type of maintenance.

In a further embodiment, a method of providing event information includes receiving event indications from a plurality of event-detecting applications. Each event indication includes respective event information that is organized in a respective indication format. Each respective indication format is both dependent upon a respective event-detecting application and distinct from other respective indication formats. The respective event information of each event indication is transformed to include a standard indication format and stored in an event data store. Upon receiving an event-indication sorting criterion that is usable to isolate a portion of the event indications, the portion is presented.

### BRIEF DESCRIPTION OF THE DRAWINGS

Embodiments are described in detail below with reference to the attached drawing figures, wherein:

FIG. 1 is a block diagram of an exemplary computing environment suitable to implement embodiments of the present invention;

FIG. 2 is an exemplary system architecture suitable to implement embodiments of the present invention;

FIGS. 3-5 each include a flow diagram of a method in accordance with an embodiment of the present invention; and

FIG. 6 is a screenshot of an event repository in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” might be used herein to connote different elements of methods employed, the terms should not be interpreted as implying any particular order among or between various steps herein disclosed unless and except when the order of individual steps is explicitly stated.

An embodiment of the present invention is directed to providing event information that is received from various sources in a healthcare environment. In an exemplary embodiment, the information that is received from the various sources is converted to a standardized format. Once converted to a standardized format, the information is filtered according to various criteria (e.g., source device, recipient component, event type, source location, etc.). After filtering, the information is compared to a rules engine to determine whether additional processing and/or routing is appropriate. Additional processing might include using the information to generate a notification and a report.

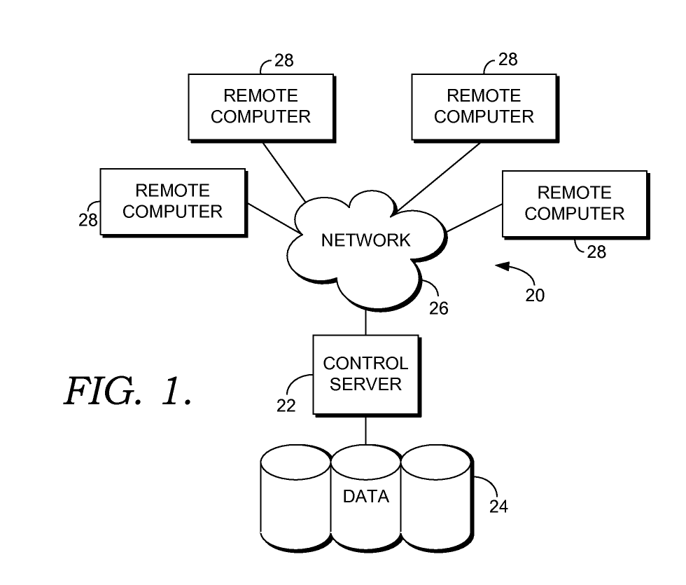

Having briefly described embodiments of the present invention, an exemplary operating environment suitable for use in implementing embodiments of the present invention is described below. Referring to FIG. 1 an exemplary computing environment (e.g., medical-information computing-system environment) with which embodiments of the present invention may be implemented is illustrated and designated generally as reference numeral 20. The computing environment 20 is merely an example of one suitable computing environment and is not intended to suggest any limitation as to the scope of use or functionality of the invention. Neither should the computing environment 20 be interpreted as having any dependency or requirement relating to any single component or combination of components illustrated therein.

The present invention might be operational with numerous other general purpose or special purpose computing system environments or configurations. Examples of well-known computing systems, environments, and/or configurations that might be suitable for use with the present invention include personal computers, server computers, hand-held or laptop devices, multiprocessor systems, microprocessor-based systems, set top boxes, programmable consumer electronics, network PCs, minicomputers, mainframe computers, distributed computing environments that include any of the above-mentioned systems or devices, and the like.

The present invention might be described in the general context of computer-executable instructions, such as program modules, being executed by a computer. Exemplary program modules include routines, programs, objects, components, and data structures that perform particular tasks or implement particular abstract data types. The present invention might be practiced in distributed computing environments where tasks are performed by remote processing devices that are linked through a communications network. In a distributed computing environment, program modules might be located in association with local and/or remote computer storage media (e.g., memory storage devices).

With continued reference to FIG. 1, the computing environment 20 includes a general purpose computing device in the form of a control server 22. Exemplary components of the control server 22 include a processing unit, internal system memory, and a suitable system bus for coupling various system components, including database cluster 24, with the control server 22. The system bus might be any of several types of bus structures, including a memory bus or memory controller, a peripheral bus, and a local bus, using any of a variety of bus architectures. Exemplary architectures include Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

The control server 22 typically includes therein, or has access to, a variety of computer-readable media, for instance, database cluster 24. Computer-readable media can be any available media that might be accessed by server 22, and includes volatile and nonvolatile media, as well as, removable and nonremovable media. Computer-readable media might include computer storage media. Computer storage media includes volatile and nonvolatile media, as well as, removable and nonremovable media implemented in any method or technology for storage of information, such as computer-readable instructions, data structures, program modules, or other data. In this regard, computer storage media might include RAM, ROM, EEPROM, flash memory or other memory technology, CD-ROM, digital versatile disks (DVDs) or other optical disk storage, magnetic cassettes, magnetic tape, magnetic disk storage, or other magnetic storage device, or any other medium which can be used to store the desired information and which may be accessed by the control server 22. Combinations of any of the above also may be included within the scope of computer-readable media.

The computer storage media discussed above and illustrated in FIG. 1, including database cluster 24, provide storage of computer-readable instructions, data structures, program modules, and other data for the control server 22.

The control server 22 might operate in a computer network 26 using logical connections to one or more remote computers 28. Remote computers 28 might be located at a variety of locations in a medical or research environment, including clinical laboratories (e.g., molecular diagnostic laboratories), hospitals and other inpatient settings, veterinary environments, ambulatory settings, medical billing and financial offices, hospital administration settings, home healthcare environments, and clinicians' offices. Clinicians might include a treating physician or physicians; specialists such as surgeons, radiologists, cardiologists, and oncologists; emergency medical technicians; physicians' assistants; nurse practitioners; nurses; nurses' aides; pharmacists; dieticians; microbiologists; laboratory experts; laboratory technologists; genetic counselors; researchers; veterinarians; students; and the like. The remote computers 28 might also be physically located in nontraditional medical care environments so that the entire healthcare community might be capable of integration on the network. The remote computers 28 might be personal computers, servers, routers, network PCs, peer devices, other common network nodes, or the like and might include some or all of the elements described above in relation to the control server 22. The devices can be personal digital assistants or other like devices.

Exemplary computer networks 26 include local area networks (LANs) and/or wide area networks (WANs). Such networking environments are commonplace in offices, enterprise-wide computer networks, intranets, and the Internet. When utilized in a WAN networking environment, the control server 22 might include a modem or other means for establishing communications over the WAN, such as the Internet. In a networked environment, program modules or portions thereof might be stored in association with the control server 22, the database cluster 24, or any of the remote computers 28. For example, various application programs may reside on the memory associated with any one or more of the remote computers 28. It will be appreciated by those of ordinary skill in the art that the network connections shown are exemplary and other means of establishing a communications link between the computers (e.g., control server 22 and remote computers 28) might be utilized.

In operation, a clinician might enter commands and information into the control server 22 or convey the commands and information to the control server 22 via one or more of the remote computers 28 through input devices, such as a keyboard, a pointing device (commonly referred to as a mouse), a trackball, or a touch pad. Other input devices include microphones, satellite dishes, scanners, or the like. Commands and information might also be sent directly from a remote healthcare device to the control server 22. In addition to a monitor, the control server 22 and/or remote computers 28 might include other peripheral output devices, such as speakers and a printer.

Although many other internal components of the control server 22 and the remote computers 28 are not shown, those of ordinary skill in the art will appreciate that such components and their interconnection are well known. Accordingly, additional details concerning the internal construction of the control server 22 and the remote computers 28 are not further disclosed herein.

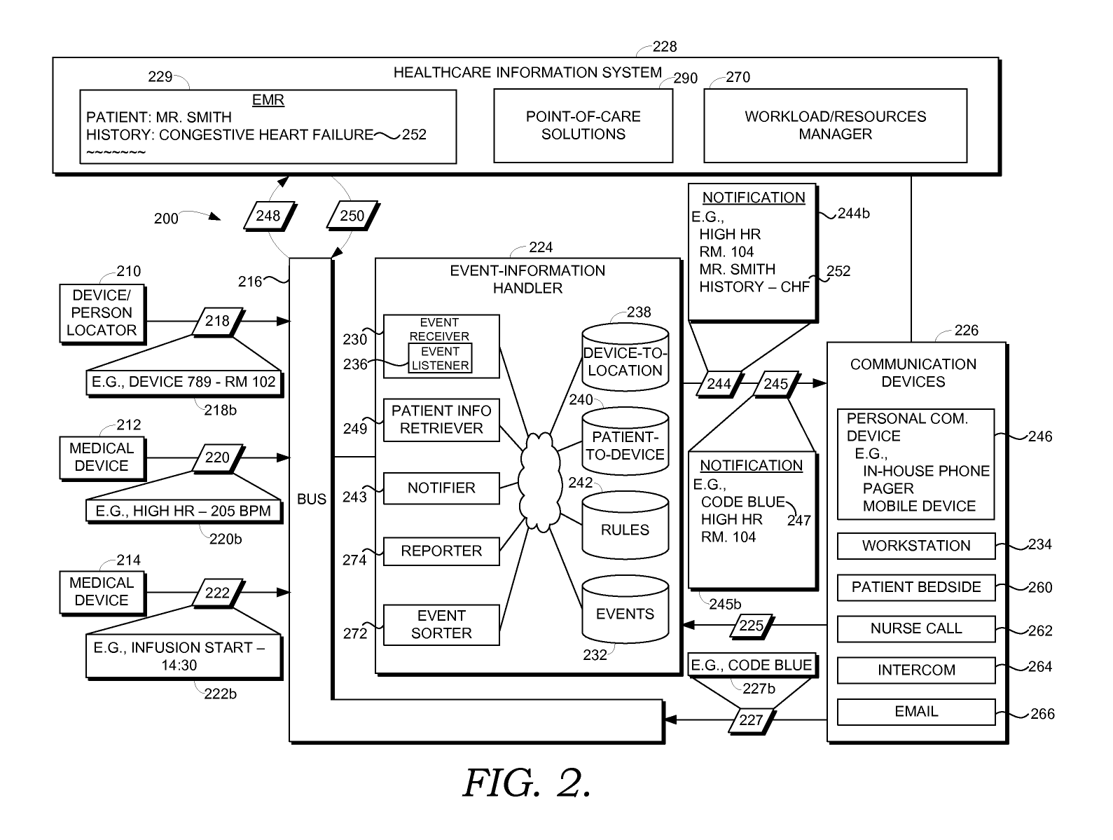

Turning now to FIG. 2, a schematic diagram depicts an operating environment, identified generally by reference numeral 200, that is suitable to practice an embodiment of the present invention. FIG. 2 includes various components that communicate with one another, including device/person locator 210, medical devices 212 and 214, communication devices 226, bus 216, event-information handler 224, and healthcare information system 228. In one embodiment of the present invention, various information created by each individual component is routed to and managed by event-information handler 224, as opposed to, each information-producing component directly sharing and managing information as a separate entity. For example, data 218, 220, and 222 is communicated to bus 216, which might then forward the data to event-information handler 224 to be further processed and routed. In a further example, data 227 is communicated to bus 216, which forwards information to event-information handler 224. Before describing in more detail how these components communicate, each component will be generally described.

In an embodiment of the present invention, device/person locator 210 includes a device that is used to locate a person and/or a device. For example, device/person locator 210 might include a scanner configured to recognize a barcode on a medical device. Alternatively, device/person locator 210 might be configured to recognize a tagged item, such as an identification badge or other transmitter, when the tagged item passes a scanning device. In an embodiment of the present invention, once device/person locator 210 detects a location of a device or person, that information is communicated to other components (e.g., bus 216) of operating environment 200, as will be further discussed below. Moreover, device/locator 210 might also receive information from other components, as will also be described below.

In another embodiment of the present invention, medical devices 212 and 214 include devices that are used to monitor and/or administer care to a patient in a healthcare setting. For example, medical devices 212 and 214 might include monitors, infusion pumps, cardiac ventilators, balloon pumps, patient beds, sequential-compression devices, electronic security devices, and vital-sign detecting devices. Medical devices 212 and 214 generate various data (e.g., measured heart rate) that, as described in more detail below, is communicated to other components (e.g., bus 216) of operating environment 200. Moreover, medical devices 212 and 214 might also receive information from components of operating environment 200.

In a further embodiment of the present invention, healthcare information system 228 includes an integrated system of healthcare-related information that is usable by a healthcare facility to operate and provide patient care. For example, healthcare information system 228 includes an electronic medical record 229 (also referred to herein as “EMR”), a point-of-care solutions component 290, and a workload/resources management component 270. EMR 229 includes an electronic version of patient records, such as examination reports, testing and lab results, medical history, etc. Point-of-care solutions component 290 includes information that is provided at a patient's point-of-care (e.g., patient bedside) to assist healthcare professionals to provide appropriate care. Workload/resources management component 270 includes information that evaluates past and current use of personnel and resources and suggests a future allocation thereof. In an embodiment of the present invention, healthcare information system 228 receives information from other components, as will be described in more detail below. Moreover, healthcare information system 228 might also generate information that is communicated to other components of operating environment 200.

In a further embodiment of the present invention, communication devices 226 include devices that are used within a healthcare facility to receive and send information. Communication devices 226 also facilitate requests to receive additional information. Exemplary communication devices 226 include personal communication devices 246, a workstation 234, patient bedside devices 260, nurse call 262, an intercom system 264, and an email system 266. Personal communication devices 246 include devices that are used by an individual to receive and send information, such as an in-house phone, a pager, and a mobile device. Workstation 234 includes a remote computer terminal that is used to present information to a user and receive input. Workstation 234 might be set up at a nurse's station to or at a patient bedside. Patient bedside 260 includes a communication device that presents information to and receives information that is input by a patient. For example, a patient bedside 260 communication device might present learning modules to a patient and/or receive a patient's electronic signature on a consent form. Nurse call 262 includes communication devices that present information to and receive information from a nurse (or other healthcare professional), such as in a patient's room. Intercom 262 includes communication devices that receive and announce information, such as using speakers. Email 266 might be implemented using one or more of the other communication devices 226 (e.g., personal communication device 246, workstation 234, and patient bedside 260) to send and receive messages (e.g., email messages, SMS messages, etc.) to various users. Accordingly, in an embodiment of the present invention, communication devices 226 present to users information that is received from other components of operating environment 200. For example, personal communication device 246 might display, or intercom 264 might announce, information from medical device 220. Moreover, communication devices 226 might also generate information (e.g., code-blue alert) that is communicated to other components of operating environment 200. Communication devices 226 also communicate to other components of operating environment 200 requests to receive additional information. For example, personal communication device 246 might communicate a request of a physician to receive information from EMR 229.

As previously indicated, and as depicted in FIG. 2, each of device/person locator 210, medical devices 212 and 214, healthcare information system 228, and communication devices 226 are in communication with bus 216. Bus 216 generally provides a connection framework for these components by creating and managing all connections, providing a messaging architecture to facilitate an exchange of information between the various components of FIG. 2, and providing general operational and management capabilities for connected devices. In one embodiment, device/person locator 210, medical devices 212 and 214, communication devices 226, and healthcare information system 228 communicate with bus 216 as described in U.S. patent application Ser. No. 12/347,475 (U.S. Pat. App.'475), which is incorporated herein by reference. For example, medical devices 212 and 214 might include various different types of medical devices (e.g., monitors, infusion pumps, cardiac ventilators, balloon pumps, patient beds, sequential compression devices, electronic security devices, vital-sign detecting devices, etc.) that are manufactured by various different vendors. As such, components of FIG. 2 might communicate with bus 216 via a gateway (e.g, device gateway or internal gateway), an adapter, or by any other means described by U.S. Pat. App. '475. In a further embodiment, bus 216 includes those capabilities described in U.S. Pat. App. '475. As indicated in U.S. Pat. App. '475, once data is received (e.g., data 218, 220, 222, and 227) it can be sorted and routed to other applications. In an embodiment of the present invention, such applications are included in an event-information handler 224. As such, bus 216 might receive information (e.g., data 218, 220, and 222) and route the data to event-information handler 224. Moreover, bus 216 might receive information 227 from communication devices 226 and route the information to event-information handler 224. In a further embodiment, bus 216 receives information 250 from healthcare information system 228 and routes the information to event-information handler 224. In another embodiment, bus receive information from event-information handler 224 and routes the information to other components. For example, bus 216 routes information 248 to healthcare information system 228.

In an embodiment of the present invention, event-information handler 224 communicates with bus 216 and functions to consolidate and manage information received from the various components of operating environment 200. In a further embodiment, instead of components communicating directly with one another, information is routed through and normalized by event-information handler 224. Event-information handler 224 allows for consolidation and communication of information from various sources, which are not easily integrated or combinable by direct communication. For example, event-information handler 224 allows for information from medical devices 212 and 214 to be packaged with information from healthcare information system 228 in order to generate and communicate a more information-rich notification to a notification recipient (e.g., personal communication device 246). Moreover, a set of normalized information is more easily sorted and reported than a set of information that organized in alternative formats of various information sources.

In a further embodiment, event-information handler 224 includes various components that exchange information with one another, such as an event receiver 230, a patient-information retriever 249, a notifier 243, a reporter 274, an event sorter 272, a device-to-location datastore 238, a patient-to-device datastore 240, a rules database 242, and an events database 232. As discussed in more detail below, an event receiver 230 might receive and process event indications (e.g., data 218, 220, and 222), which are then stored in events database 232. Patient-info retriever 249 functions to retrieve patient information from datastores, such as from patient-to-device datastore 240 and a patient EMR 229. Notifier 243 functions to compose and send notifications to notification recipients, such as communication devices 226. Exemplary notifications are depicted in FIG. 2 by reference numerals 244b and 245b and will be described in more detail below. Event sorter receives sorting criteria and identifies event information in events datastore 232 that matches the sorting criteria. Reporter 274 facilitates reporting of event information that is stored in events datastore 232, such as event information identified by event sorter 272.

Management and communication of information between the various components of operating environment 200 will now be described in more detail. In an embodiment of the present invention, each of data 218, 220, and 222 is a separate event indication, which describes an event detected by device/person locator 210 and medical devices 212 and 214 (respectively). As used herein “event” describes an occurrence that is detected by a component. Exemplary events include detecting that a measured value has exceeded a threshold value, detecting that a measured value has increased or decreased, detecting a person or a piece of equipment (e.g., detecting arrival at or departure from a location), detecting that a device has been connected to or disconnected from bus 216, detecting that a device has been connected to or disconnected from a patient, detecting that an input has been entered, detecting that an alarm has been activated (e.g., code blue), and detecting that a device has started or stopped measuring a value of a patient. As used herein “event indication” includes a string of text that describes an event. For example, an event indication might include a set of text (e.g., words and numerals) that describe an occurrence that is detected by a component. As will be described in more detail below, event indications might be generated by components (e.g., person/device locator 210, medical devices 212 and 214, communication devices 226, and healthcare information system 228) that are external to both bus 216 and event-information handler 224 Such event indications that are generated by external components are sometimes referred to herein as “external event indications”. In a further embodiment, event indications are also generated by either bus 216 or event-information handler 224 and are sometimes referred to herein as “internal event indications”.

As previously indicated, device/person locator 210 might include a scanner configured to recognize a barcode on a medical device. Alternatively, device/person locator 210 might be configured to recognize a tagged item, such as an identification badge or other transmitter, when the tagged item passes a scanning device. As such, when device/person locator 210 detects an event (e.g., detects a medical device or a person), data 218 (i.e., event indication) is communicated to bus 216. An exploded view 218b of data 218 is shown in FIG. 2 for exemplary purposes and illustrates exemplary event information, which reads “Device 789—Rm 102” and indicates that a device with an identification number of 789 was scanned in Room 102. Via bus 216, data 218 is communicated to other components of FIG. 2, such as event-information handler 224. In a further example, medical device 212 might include a device that is measuring a value of a patient connected to medical device 212. As such, when medical device 212 detects an event (e.g., increase or decrease in a measured value), data 220 (i.e., event indication) is communicated to bus 216. An exploded view 220b of data 220 is shown in FIG. 2 for exemplary purposes and illustrates exemplary event information, which reads “High HR—205 bpm” and indicates that medical device 212 detected a high heart rate. Via bus 216, data 220 is communicated to other components of FIG. 2, such as event-information handler 224. In another example, medical device 214 might include a medical device that infuses fluids or medication to a patient. As such, when medical device 214 detects an event (e.g., initiating infusion), data 222 (i.e., event indication) is communicated to bus 216. An exploded view 222b of data 222 is shown in FIG. 2 for exemplary purposes and illustrates exemplary event information, which reads “Infusion Start—14:30” and indicates that device 214 began infusing at 2:30 PM. Via bus 216, data 222 is communicated to other components of FIG. 2, such as event-information handler 224.

In a further exemplary embodiment, data 227 is an event indication that describes an event detected by one of communication devices 226. For example, patient bedside 260 might detect that a patient has executed a consent form and send an appropriate event indication, which is communicated to event-information handler 224 via bus 216. Alternatively, nurse call 262 might detect an activation of a call type (e.g., code blue), in which case an appropriate event indication (e.g., data 227) is sent. An exploded view 227b of data 227 is shown in FIG. 2 for exemplary purposes and illustrates exemplary event information, which reads “Code Blue” and indicates that a code-blue alarm was input into a communication device 226 (e.g., nurse call 262). Via bus 216, data 227 is communicated to other components of FIG. 2, such as event-information handler 224.

In a further embodiment of the present invention, event indications are generated by healthcare information system 228. For example, event indications (e.g., data 250) might describe that a lab result has been obtained, that an order relating to a patient's treatment has been submitted, or that a patient has been assigned to a specific location. Via bus 216, data 250 is communicated to other components of FIG. 2, such as event-information handler 224.

In an embodiment of the present invention, event indications are generated internally by bus 216 and/or event-information handler 224 as the result of event indications that are received from external devices, such as device/person locator 210, medical devices 212 and 214, healthcare information system 228 and communication devices 226. For example, event indications might be generated in response to a device being connected to or disconnected from a patient, a device being connected to or disconnected from bus 216, and a device starting or stopping performance of a function (e.g., infusion). An example of an internally generated event indication includes a notification that is communicated to workload/resources manager and that indicates a device is available to be used. Such an internally generated event indication might be generated as the result of another event indication that was received from a medical device and that indicated that the medical device was disconnected from a patient. In one embodiment, bus 216 creates internally generated event indications, which are then communicated to event-information handler 224 for subsequent processing. In an alternative embodiment, event-information handler 224 creates internally-generated event indications.

Exemplary event indications are depicted below in Table 1 to illustrate event categories and event types that are included in an embodiment of the present invention. In an embodiment of the present invention, event indications listed in Table 1 are externally-generated event indications, which are generated by device/person locator 210 or medical devices 212 or 214. For example, categories I and II might be generated by medical devices 212 or 214 and category III might be generated by device/person locator 210.

TABLE 1
I. Device Lifecycle Events

A. DeviceConnectEvent
B. DeviceDisconnectEvent

```
  1. DISCONNECT_REASON_ASSUME_DEVICE_CONTROL
  2. DISCONNECT_REASON_DEVICE_CABLE_DISCONNECT
  3. DISCONNECT_REASON_DEVICE_HOST_SHUTDOWN
  4. DISCONNECT_REASON_DEVICE_REREGISTRATION
  5. DISCONNECT_REASON_DEVICE_UNRESPONSIVE
  6. DISCONNECT_REASON_ENV_CHANGE
  7. DISCONNECT_REASON_HEARTBEAT_LOST
  8. DISCONNECT_REASON_MANAGEMENT_STOP
  9. DISCONNECT_REASON_NETWORK_CONNECTION_FAILURE
10. DISCONNECT_REASON_UNKNOWN
```

C. PatientAssociatedToDeviceEvent
D. PatientDeviceAssociationChangeEvent
E. PatientDisassociatedToDeviceEvent

II. Event Notification System

A. ENSDeviceEvent

```
  1. DEPLETED_BATTERY
  2. LOW_BATTERY
  3. UNKNOWN
```

B. ENSInfusionEvent

```
  1. AIR_IN_LINE
  2. ALARM_SILENCED
  3. BOLUS
  4. CIRCUIT_MALFUNCTION
  5. COMPLETE
  6. DOOR_OPEN
  7. DOWNSTREAM_OCCLUSION
  8. HIGH_BACKPRESSURE
  9. LOW_VOLUME
10. PROGRAM_VOLUME_RESET
11. PUMP_CONNECTED
12. PUMP_DISCONNECTED
13. PUMP_START
14. PUMP_STOP
15. RATE_CHANGE
16. UNKNOWN
17. UPSTREAM_OCCLUSION
```

C. ENSPhysiologicalEvent

```
  1.APNEA
  2. BLOOD_PRESSURE_DIASTOLIC_HIGH
  3. BLOOD_PRESSURE_DIASTOLIC_LOW
  4. BLOOD_PRESSURE_MEAN_PRESSURE_HIGH
  5. BLOOD_PRESSURE_MEAN_PRESSURE_LOW
  6. BLOOD_PRESSURE_SYSTOLIC_HIGH
  7. BLOOD_PRESSURE_SYSTOLIC_LOW
  8. HARDWARE_MALFUNCTION
  9. HEART_RATE_HIGH
10. HEART_RATE_LOW
11. LEAD_FAILURE
12. O2_CONCENTRATION_HIGH
13. O2_CONCENTRATION_LOW
14. PROBE_OFF_PATIENT
15. RESPIRATORY_RATE_HIGH
16. RESPIRATORY_RATE_LOW
17. SPO2_SATURATION_HIGH
18. SPO2_SATURATION_LOW
19. TEMPERATURE_HIGH
20. TEMPERATURE_LOW
```

D. ENSVentilatorEvent

```
  1. AIRWAY_PRESSURE_HIGH
  2. AIRWAY_PRESSURE_LOW
  3. APNEA
  4. BAROMETER_HIGH
  5. BAROMETER_LOW
  6. CMV_POTENTIOMETER_ERROR
  7. CO2_CONCENTRATION_HIGH
  8. CO2_CONCENTRATION_LOW
  9. COMMUNICATION_ERROR_INTERNAL
10. EXPIRED_ MINUTE_VOLUME_HIGH
11. EXPIRED_MINUTE_VOLUME_LOW
12. FIO2_HIGH
13. FIO2_LOW
14. GAS_SUPPLY_LOW
15. IE_RATIO
16. INSPIRED_MINUTE_VOLUME_HIGH
17. INSPIRED_MINUTE_VOLUME_LOW
18. LEAKAGE
19. MODULE_ERROR
20. NO_PATIENT_EFFORT
21. O2_CONCENTRATION_HIGH
22. O2_CONCENTRATION_LOW
23. O2_POTENTIOMETER_ERROR
24. PEEP_HIGH
25. PEEP_LOW
26. RESPIRATORY_RATE_HIGH
27. RESPIRATORY_RATE_LOW
28. SPO2_SATURATION_HIGH
29. SPO2_SATURATION_LOW
30. TIDAL_VOLUME_EXPIRED_HIGH
31. TIDAL_VOLUME_EXPIRED_LOW
32. TIME_WAITING
33. TUBE_OBSTRUCTION
```

III. Real-time Position Tracking

A. RtlsLocationChangeEvent
B. RtlsTagAssignmentEvent
C. RtlsTagEvent
D. RtlsTagUnassignmentEvent

In an embodiment of the present invention, an event indication (either externally generated or internally generated) that is received by event-indication handler 224 is filtered according to raw information of the event indication. For example, an event indication might be filtered according to an identifier of a source device (e.g., device/person locator 210 and medical devices 212 and 214), a Java class name of a component that received the event indication, a Java class name of the raw incoming event indication, and location information (if provided). Filters might also include device name, device type, connection state, location, event type, event detail, device association status.

In an alternative embodiment, instead of immediately filtering an event indication, the event indication is processed before being filtered, such as by conforming data of the event indication and retrieving additional information associated with the event indication. In an embodiment of the present invention, data 218, 220, 222, and 227 are communicated to bus 216, which conforms data 218, 220, 222, and 227 into a common structure that is more easily used by other components and applications that might lack specific knowledge of a model of the source device of data 218, 220, 222, and 227. That is, information is normalized into a common format. Data 218, 220, 222, and 227 are then communicated to event-information handler 224 to be further processed. In a further embodiment, event receiver 230 receives data 218, 220, 222, and 227. Event receiver 230 might include event-listener components 236 that are each responsible for listening to a particular respective topic of bus 216 and capturing event indications (e.g., data 218, 220, 222, and 227) that are categorized under that topic. For example, an emergency-notification listener might listen for alarm-triggering event indications (e.g., data 220 and 227) and a device-locator listener might listen for event indications (e.g., data 218) that indicate a location of a device.

In a further embodiment of the present invention, once an event indication is received, event-listener components 236 conform each event indication to include specific context. In one embodiment of the present invention, all event indications are conformed based on a standard indication format, such that each event indication includes the same categories of data. These categories of data include an effective date and time of the event described by the event indication, identification of a source device (e.g., components 210, 212, 214, and 262) that generated the event indication, identification of a location associated with the source device, identification of a person (e.g., patient) associated with the source device, a coded priority of the event indication, and event acknowledgement information (if available). In a further embodiment, in order to process an event indication to include certain data, other databases must be referenced. For example, data 220 might identify medical device 212; however, data 220 might not identify either a location of medical device 212 or a person associated with medical device 212. Accordingly, the location of medical device 212 might be retrieved from a device-to-location database 238 and a person associated with medical device 212 might be retrieved from a patient-to-device database 240. In an embodiment of the present invention, associations stored in device-to-location database 238 might be created by an RTLS tag on a device, a device association with a static location, or a device connection to bus 216 at a static location. In embodiments of the present invention, associations stored in patient-to-device database 240 are created pursuant to methods described in U.S. patent application Ser. No. 12/347,475.

In a further embodiment, context that is additional to the standard indication format is added to event indications based on a type of the event indication. A type of event indication might depend on whether the event indication was received from an external source or was generated internally as the result of an observed condition. For example, one type of event indication is received from an external system, such as medical devices 212 and 214, device/person locator 210, healthcare information system 228, and communication devices 226 (e.g., nurse call 262). Event indications that are received from an external system include alarm-triggering event indications (e.g., data 220 that indicates “High HR—205 BPM”) and tracking event indications (e.g., data 218 that indicates “Device 789—RM 102”). An event indication that is received from external sources is supplemented to include received-event information, such as a date and time at which the event indication was received; a category of the event indication (e.g., emergency notification service and device/person-locator service); an event type (e.g., device started, device stopped, high heart rate, low heart rate, and device located); a value reported from the source (e.g., 205 bpm, Rm. 102, and 14:30); an event message subject and event message body (if available); a serialized representation of the original received event indication (e.g., data 218, 220, and 222); a Java class name identification of the component that received the event indication; and/or a Java class name identification of the event object that was received.

As previously indicated, in an embodiment of the present invention, an event that is received from an external source might serve either an alarm-triggering purpose or a tracking purpose. For example, if an event is designed to trigger an alarm, the alarm-triggering event indication that is received from an external component is supplemented to include alarm-triggering information, such as an alarm level (e.g., advisory, warning, and crisis); an alarm state (e.g., active, silenced, and cleared); an alarm text that describes the event (e.g., leads failed); an alarm instance count of alarms that report repeatedly until cleared; and/or a Java class name identification of the component that identified the event as an alarm-triggering event (i.e., if the event indication was not already marked as alarm-triggering when it was received). The supplemented alarm-triggering information is added to the standard-indication-format information and the received-event information. In alternative embodiments of the present invention, an event indication that is received from an external source might serve tracking purposes, as opposed to alarming purposes, in which case the event indication is supplemented with tracking information, such as a unique identifier of the person or object whose position is being reported and/or a unique identifier of the tracking tag that initiated the tracking event. The tracking information is added to the standard-indication-format information and the received-event information.

In further embodiments of the present invention, an alternative type of event indication is generated internally as the result of conditions that are detected based on event indications that are received from external sources. For example, a utilization level of a medical device might trigger an internal event indication, which indicates that the medical device needs to be serviced. A utilization level (e.g., frequency of utilization, duration of utilization, utilization load, etc.) might be determined based on various factors, such as cumulative connection time to bus 216, cumulative connection time to one or more patients, and cumulative run time. In one embodiment of the present invention, utilization levels are determined based on active-state-duration values. For example, data 222 might be recorded and combined with other event indications that indicate start and stop times of medical device 214. Durations of time between start and stop indications can be used to determine an active-state-duration value. Based on the combined start and stop times (e.g., combined active-state-duration values) a determination could be made that medical device 214 has run for a specific duration of time that requires maintenance to be performed on medical device 214. As such, an internal event indication might be generated that indicates that medical device 214 is required to receive service before further use. In embodiments of the present invention, internal event indications include standard-indication-format information that was previously described.

In further embodiments of the present invention, once an event indication has been conformed to include all types of appropriate information (e.g., standard-indication-format information, received-event information, alarm-triggering information, and tracking information) the event indication is further processed, such as by filtering the event, referencing a rules engine 242, and/or storing the event indication in events datastore 232.

In an embodiment of the present invention event indications are filtered by information included in the standard-indication-format information and received-event information. For example, an event indication might be filtered by an associated location (e.g., a location retrieved from datastore 238) or an associated person (e.g., a person identified in datastore 240). Moreover, event indications might be filtered by information included in alarm-triggering information or tracking information. As previously indicted filtering might include by device name, device type, connection state, location, event type, event detail, device association status, etc.

The rules engine 242 is responsible for analyzing event indications and determining if a rule exists for a particular alarm-triggering event indication (e.g. high heart rate), tracking event indication, (e.g., location of patient), and internally created event indication (e.g., service required). If a rule exists that applies to particular data, the rules engine 242 inspects the data of the event indication to determine whether a rule has been satisfied (e.g., whether a value is above or below a threshold value). If the rule has been satisfied, the rules engine triggers subsequent action, such as triggering a notifier component 243 to send a notification (e.g., data 244 and 245) to a notification recipient (e.g., communication device 226). Alternatively, if a notification is not to be sent to a notification recipient, the rules engine might trigger a log event, which creates a stored record that a rule was violated. For example, rules engine 242 might dictate that if a particular device (e.g., medical device 212) detects a heart rate that exceeds 200 beats-per-minute, notification 244 should be sent to communications device 246. In another example, a rule might dictate that a notification 248 should be sent to a medical resources department when medical device 214 is disconnected from bus 216 and is available to be used to treat other patients.

In embodiments of the present invention rules engine 242 is extensible, such that new rules can be created and added to rules engine 242. One type of rule might be created when a healthcare professional subscribes to receive notifications that are generated from event indications of a certain medical device. In an embodiment of the present invention, rules engine 242 is configurable to generate notifications of any event that is detected. That is, not only are alarm-triggering events (e.g., cardiac arrest) reportable to subscribing healthcare professionals, but any event (e.g., high/low heart rate, increase/decrease in heart rate, start/stop infusion, etc.) that is captured by event-information handler 224 is also reportable. In this respect, an embodiment of the present invention enables notification rules of a healthcare professional to be customizable based on a particular patient. A healthcare professional might generally not want to receive notifications of a high heart rate; however, because of a particular patient's condition, the healthcare professional might want to receive notifications of the patient's high heart rate. As such, an embodiment of the present invention allows the healthcare professional to create a notification rule that applies to the patient.

In a further embodiment of the present invention, additional information is retrieved prior to event-information handler 224 sending notifications (e.g., notifications 244 and 245). For example, as previously described, a patient identifier of a patient that is associated with a medical device is retrievable from patient-to-device datastore 240. As such, using the patient identifier, EMR 229 might be referenced to obtain additional information regarding the patient. For example, a patient information retriever 249 might send via bus 216 a request 248 to receive medical history, a diagnosis, current treatment, critical lab result(s), and other information stored in EMR 229, in order to create a more information-rich notification 244. An expanded view 244b of notification 244 is shown in FIG. 2. Expanded view 244b illustrates that notification 244 includes both information included in event indication 220, as well as, information 252 that was retrieved from EMR 229. Alternatively, a patient identifier might be used to reference events datastore 232 to retrieve stored event indications that are associated with the patient identifier, such as an event indication from another medical device associated with the patient. For example, an event indication (e.g., data 227) from nurse call 262 might have been previously communicated to event-information handler 224 and stored in events datastore 232. As such, the event indication from nurse call 262 could be retrieved and presented together with another event indication. An expanded view 245b of notification 245 is shown in FIG. 2. Expanded view 245b illustrates that notification 245 includes both information included in event indication 220, as well as, information 247 that was received from nurse call component 262.

In an embodiment of the present invention, event indications are used in various ways to generate notifications, such as notifications 244 and 245. Additional types of notifications that are enabled by the present invention include: a dementia-roaming notification that is published (e.g., to com device 246) when a dementia-suffering patient exits his/her room; a device-maintenance notification that is provided (e.g., to nurse call 262) when a healthcare professional associates a pump with a patient that is due for maintenance, thereby alerting the healthcare professional to select a different pump; a device-maintenance notification that is provided when a healthcare professional disassociates a pump from a patient, thereby alerting the healthcare professional to set the pump aside and alerting a biomedical equipment department (e.g., via email 266) to perform the maintenance; infusion-completion notification that informs a healthcare professional that an infusion has reached a predetermined completion percentage; patient-fall-monitoring that provides a notification to a healthcare professional that a patient, who is considered to be a fall risk, has left a bus-connected bed; and a presurgery-condition notification that, when a position tracking system sends an event indication reporting that a patient has entered a surgical operating suite and a predetermined set of condition are not met, informs surgical staff by a spoken message (e.g., via intercom 264) that the condition is not met.

In an embodiment of the present invention, a notification recipient includes one or more of various components of operating environment 200. FIG. 2 depicts that event-information handler 224 communicates event notifications 244 and 245 to communication devices 226. For example, event notifications 244 and 245 might be displayed on personal communication device 246 (e.g., mobile device or pager) or might be announced using intercom 264. Alternatively, notifications might be communicated to patient bedside to inform a patient of various information. For example, if a device to which the patient is connected begins to sound an alarm, a notification might be sent to patient bedside 260 to explain the alarm. Furthermore, a notification might be communicated to nurse call 262. For example, after rules of rules database 242 are applied to an event indication, event-information handler 224 might route less critical alarms to nurse call 262 where the dome light could be illuminated, as opposed to, sending an alarm to a nurse's personal communication device 246. In a further example, if a critical lab result had been received from healthcare information system 228, a notification might be sent to patient bedside 260 informing the patient of the critical lab result.

In alternative embodiments, event indications are provided to other components of operating environment 200. A notification might also be provided to healthcare information system 228. For example, information in an event notification might be published to EMR 229, a workload/resources management component 270, or other components of healthcare information system 228. Other notification recipients might include applications that manage specific events of a particular medical device, such as an application that consumes all event history of an infusion pump.

In a further embodiment, communication devices 226 submit data 225 to event-information handler. As such, the present invention facilitates bidirectional communication between information stores and communication devices 226. For example, upon receiving a notification (e.g., notification 244), a user of personal communications device 246 might want to view additional information that is related to a patient associated with the notification and that is stored in events datastore 232, in EMR 229, or with medical device 212. Examples of such additional information include all event indications associated with the patient that are stored in events datastore 232, current treatment information of the patient stored in EMR 229, and/or recent data values that were measured by medical device 212. As such, personal communications device 246 might be used to send a request for information (e.g., data 225) to event-information handler. Upon receiving a request for additional information from a notification recipient, the source of the additional information is referenced to retrieve the requested additional information, and the additional information is provided to the notification recipient. For example, a healthcare professional (e.g., floor nurse) working in “Patient Room A” might use a mobile device to request that device data values be sent from a monitor in “Patient Room B” to his/her phone. Personal communication device might also be used to acknowledge that a notification was received or to indicate that a user is unable to accept a notification. As such, in an embodiment of the invention, a failure to acknowledge a notification creates an event escalation, whereby the notification is sent with a higher priority and/or sent to alternative recipients.

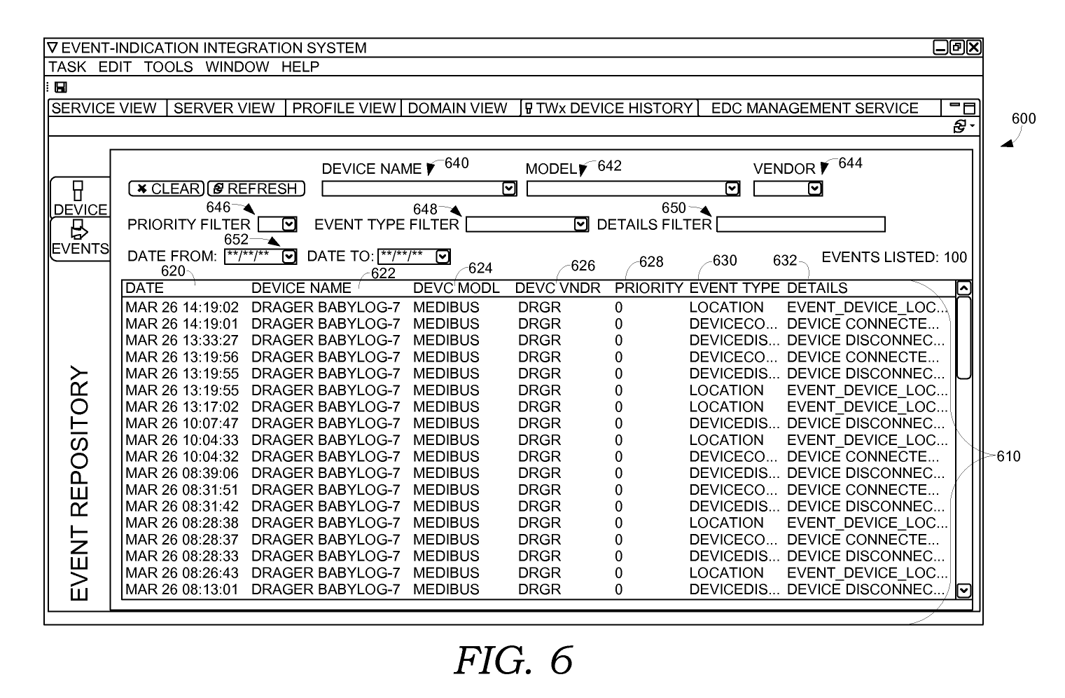

In a further embodiment of the present invention, event indications are stored in events datastore 232, which provides a long-term data store for reporting and analysis of various events and event indications. Contents of event datastore 232 are viewable, such as by using a monitor of a computing device. For example, FIG. 6 depicts an illustrative screenshot 600 of a portion of contents 610 of event datastore 232. Contents 610 include a set of event indications, each of which includes a date and time 620, identification of a source device 622, identification of a device model 624, identification of a source vendor 626, a priority score 628, identification of an event type 630, and details 632 of an event indication. Although not shown in FIG. 6, contents might also include an identification of a patient that is associated with the event indication, an identification of a location associated with the event indication, and any other information included in standard-indication-format information, received-event information, alarm-triggering information, and tracking information.

In a further embodiment, event datastore 232 is searchable and receives and processes search queries of event indications. For example, a user might want to view only those event indications that satisfy an event-indication sorting criterion. Examples of event-indication sorting criterion include an event-indication keyword, a patient identifier, an event type, a medical-device identifier, a location, an event state, an event time, and an event level. In response to a user inputting an event-indication sorting criterion, an event sorter component 272 queries the event datastore 232 to identify those event-indications that include contents that match the criterion. A reporter component 274 presents to the user event-indications that have contents that match the criterion. For example, referring to FIG. 6, portion 610 of screenshot 600 depicts various filters that might be used to sort contents 610, such as a device-name filter 640, a model filter 642, a vendor filter 644, a priority filter 646, an event-type filter 648, a details filter 650, and a date filter 652.

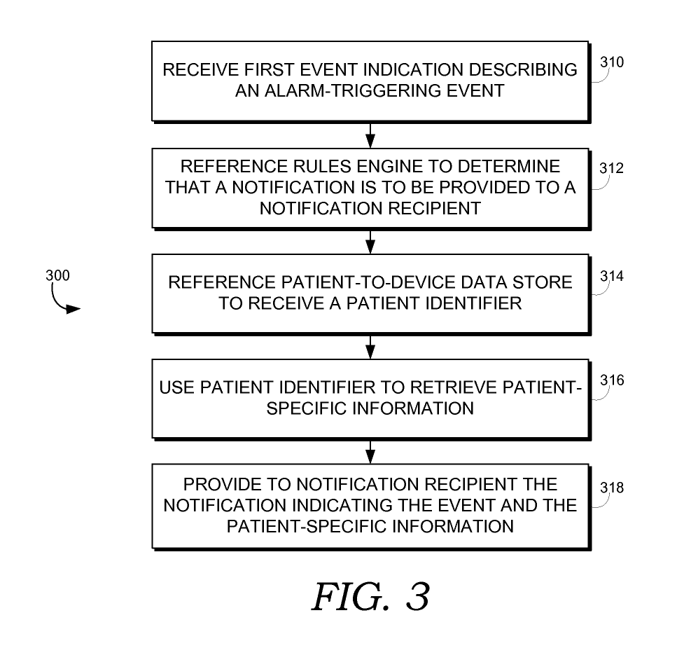

Referring to FIG. 3, an embodiment of the present invention includes a method (identified generally by reference numeral 300) of providing event information that is received from various sources in a healthcare environment. Method 300 includes, at step 310, receiving from a medical device a first event indication, which describes an alarm-triggering event detected by the medical device. Step 312 includes referencing a rules engine to determine that when the medical device detects the alarm-triggering event a notification is to be provided to a notification recipient. At step 314 a patient-to-device data store is referenced to receive a patient identifier, which identifies a patient that is associated with the medical device. Moreover, step 316 includes using the patient identifier to retrieve patient-specific information, which provides a context of the event. At step 318 the notification is provided to the notification recipient, the notification indicating both the event and the patient-specific information. In an embodiment, the present invention includes computer storage media having computer-executable instructions embodied thereon that, when executed, cause a computing device to perform method 300.

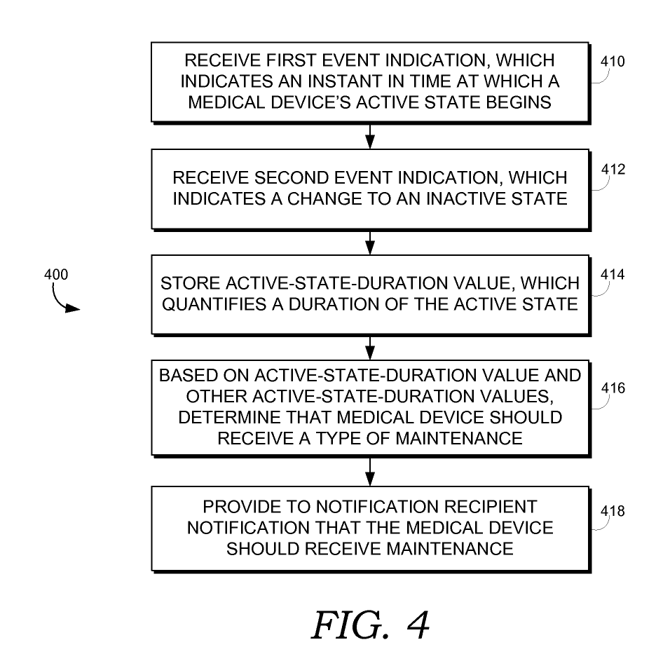

Referring to FIG. 4, an embodiment of the present invention includes a method (identified generally by reference numeral 400) of providing event information that is received from various sources in a healthcare environment. Method 400 includes, at step 410, receiving from a medical device a first event indication, which indicates an instant in time at which an active state of the medical device begins (e.g., infusion start time). Step 412 includes receiving from the medical device a second event indication, which indicates a subsequent instant in time at which the medical device changes from the active state to an inactive state (e.g., infusion stop time). At step 414 an active-state-duration value is stored that quantifies a duration of the active state between the instant in time and the subsequent instant in time, wherein the value is stored together with other active-state-duration values of the medical device. Moreover, step 416 includes, based on the active-state-duration value and the other active-state-duration values, determining that the medical device should receive a type of maintenance, and step 418 includes providing to a notification recipient a notification, which indicates that the medical device should receive the type of maintenance. In an embodiment, the present invention includes computer storage media having computer-executable instructions embodied thereon that, when executed, cause a computing device to perform method 400.

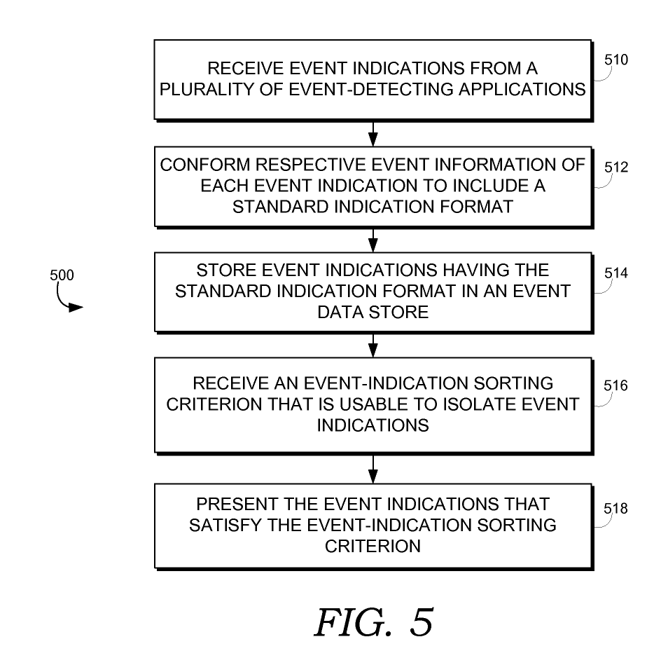

Referring to FIG. 5 an embodiment of the present invention includes a method (identified generally by reference numeral 500) of providing event information that is received from various sources in a healthcare environment. Method 500 includes, at step 510, receiving event indications from a plurality of event-detecting applications, wherein each event indication includes respective event information that is organized in a respective indication format. Each respective indication format is both dependent upon a respective event-detecting application and distinct from other respective indication formats. At step 512 the respective event information of each event indication is conformed to include a standard indication format, which includes a date and time at which a respective event occurs, an identification of an event source, an identification of a location of the event source, and an identification of a person associated with the event source. Step 514 includes storing the event indications having the standard indication format in an event data store. Moreover, at step 516, an event-indication sorting criterion is received that is usable to isolate at least a portion of the event indications, which satisfy the event-indication sorting criterion. Step 518 includes presenting the at least a portion of the event indications. In an embodiment, the present invention includes computer storage media having computer-executable instructions embodied thereon that, when executed, cause a computing device to perform method 500.

Many different arrangements of the various components depicted, as well as components not shown, are possible without departing from the scope of the claims below. Embodiments of our technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

The invention claimed is:

1. Computer storage media having computer-executable instructions embodied thereon that, when executed, cause a computing device to perform a method of providing event information that is received from various sources in a healthcare environment, the method comprising:
receiving from a medical device a first event indication, which describes an alarm-triggering event detected by the medical device;
referencing a rules engine to determine that when the medical device detects the alarm-triggering event a notification is to be provided to a notification recipient;
referencing a patient-to-device data store to receive a patient identifier, which identifies a patient that is associated with the medical device;
using the patient identifier to retrieve patient-specific information, which provides a context of the event; and
providing to the notification recipient the notification, which indicates both the event and the patient-specific information.

2. The computer storage media of claim 1, wherein the alarm-triggering event is detected by the medical device when a value that is measured by the medical device is one or more of above a first threshold value and below a second threshold value.

3. The computer storage media of claim 1,
wherein the notification recipient includes a repository application, which stores event indications that describe alarm-triggering events, and
wherein event indications are stored by the repository application in a searchable database.

4. The computer storage media of claim 1, wherein the patient-specific information includes one or more of a diagnosis of the patient and other event information of a second medical device that is associated with the patient.

5. The computer storage media of claim 1,
wherein a rule that is stored in the rules engine is created when a subscription request is received that identifies the notification recipient, and
wherein the subscription request specifies a patient, a location, an alarm type, or a combination thereof.

6. The computer storage media of claim 1, wherein the method further comprises:
receiving from the notification recipient a request to receive measured data values of the medical device, wherein the measured data values include values that are not included in the first event indication;
retrieving the measured data values; and
providing the measured data values to the notification recipient.

7. The computer storage media of claim 1,
wherein using the patient identifier to retrieve patient-specific information includes submitting a request to receive the patient-specific information that is stored in an electronic medical record of the patient, and
wherein the request includes the patient identifier.

8. The computer storage media of claim 1, wherein using the patient identifier to retrieve patient-specific information includes querying an event data store to retrieve event indications that are associated with the patient identifier.

9. The computer storage media of claim 1, wherein the method further comprises, upon receipt of the first event indication, which includes a device identifier, referencing a device-to-location data store to determine a current location of the medical device.

10. Computer storage media having computer-executable instructions embodied thereon that, when executed, cause a computing device to perform a method of providing event information that is received from various sources in a healthcare environment, the method comprising:
receiving from a medical device a first event indication, which indicates an instant in time at which an active state of the medical device begins;
receiving from the medical device a second event indication, which indicates a subsequent instant in time at which the medical device changes from the active state to an inactive state;
storing an active-state-duration value that quantifies a duration of the active state between the instant in time and the subsequent instant in time, wherein the value is stored together with other active-state-duration values of the medical device;
based on the active-state-duration value and the other active-state-duration values, determining that the medical device should receive a type of maintenance; and
providing to a notification recipient a notification, which indicates that the medical device should receive the type of maintenance.

11. The computer storage medium of claim 10, wherein the active state begins when one or more of the following occur: the medical device is connected to a bus and the medical device begins measuring a medically-significant value of a patient.

12. The computer storage medium of claim 10, wherein the medical device changes from the active state to the inactive state when one or more of the following occur: the medical device is disconnected from a bus and the medical device stops measuring a medically-significant value of a patient.

13. The computer storage medium of claim 10, wherein the active-state-duration value and the other active-state-duration values are combined to quantify a utilization value of the medical device.

14. Computer storage media having computer-executable instructions embodied thereon that, when executed, cause a computing device to perform a method of providing event information that is received from a variety of sources in a healthcare environment, the method comprising:
receiving event indications from a plurality of event-detecting applications,
(1) wherein each event indication includes respective event information that is organized in a respective indication format, and
(2) wherein each respective indication format is both dependent upon a respective event-detecting application and distinct from other respective indication formats;
conforming the respective event information of each event indication to include a standard indication format, which includes a date and time at which a respective event occurs, an identification of an event source, an identification of a location of the event source, and an identification of a person associated with the event source;
storing the event indications having the standard indication format in an event data store;
receiving an event-indication sorting criterion that is usable to isolate at least a portion of the event indications, which satisfy the event-indication sorting criterion; and
presenting the at least a portion of the event indications.

15. The computer storage media of claim 14,
wherein the method further comprises determining that a first event indication was received from an external source and adding supplemental information to the first event indication, and
wherein the supplemental information includes a date and a time that the first event indication was received, an event category, an event type, and a reported value.

16. The computer storage media of claim 15, wherein the supplemental information includes an alarm message, which includes a severity level of the alarm, a state of the alarm, and text that describes the alarm.

17. The computer storage media of claim 15, wherein the supplemental information includes a message from a position tracking service that includes a unique identifier of at least one of a person and an object and that includes a unique identifier of a tracking tag that initiated the event indication.

18. The computer storage media of claim 14, wherein the event-indication sorting criterion includes one or more of an event-indication keyword, a patient identifier, an event type, a medical-device identifier, a medical-device location, an event state, an event time, and an event level.

19. The computer storage media of claim 14, wherein each event indication describes one or more of an arrival of the respective medical device at a first physical location, a departure of the respective medical device from a second physical location, a connection of the respective medical device to a patient, a disconnection of the respective medical device from the patient, an increase of a value that is measured by the respective medical device, a decrease of a value that is measured by the respective medical device, a connection of the respective medical device to a central bus, and a disconnection of the respective medical device from a central bus.

20. The computer storage media of claim 14, wherein the event indication satisfies the event-indication sorting criterion when content of the event indication matches the event-indication sorting criterion.
